(19) United States
(12) Patent Application Publication
(10) Pub. No.: US 2008/0151996 A1
(43) Pub. Date: Jun. 26, 2008

(54) MOVING PICTURE CODING APPARATUS AND MOVING PICTURE CODING METHOD

(76) Inventors: Koji ARIMURA, Osaka (JP); Tatsuro Juri, Osaka (JP); Hideyuki Ohgose, Osaka (JP); Katsuo Saigo, Hyogo (JP); Hiroshi Arakawa, Nara (JP); Kei Tasaka, Nara (JP); Yuki Maruyama, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/954,483

(22) Filed: Dec. 12, 2007

(30) Foreign Application Priority Data
Dec. 22, 2006 (JP) 2006-346015

(51) Int. Cl. H04N 7/40

(52) U.S. Cl. 375/240.02; 375/E07.126

(57) ABSTRACT

The moving picture coding apparatus according to the present invention includes: a decoding unit 10 which decodes an MPEG2 stream; a coding parameter extracting unit 11 which extracts a coding parameter of MPEG2 from the MPEG stream; a re-coding parameter determining unit 12 which judges, based on the coding parameter of MPEG2 extracted by the coding parameter extracting unit 11, the degree of correlation between image data coded in MPEG2 and its reference picture and determines a coding parameter of H.264 based on the result of the judgment; and a coding unit 13 which codes, in H.264, the image data decoded by the decoding unit 10, using the coding parameter of H.264 determined by the re-coding parameter determining unit 12.

### BACKGROUND OF THE INVENTION

(1) Field of the Invention

The present invention relates to a moving picture coding apparatus and a moving picture coding method, and particularly to a technique for re-coding, in H.264, image data which has been coded in MPEG2.

(2) Description of the Related Art

In recent years, AV information has increasingly been digitalized, and appliances capable of handling video signals by digitalizing them have become popularized. The video signals take up enormous amounts of information, thus, taking into account the recording capacity and transmission efficiency, it is common to reduce the amounts of information in coding of the video signals. There are international standards, namely, MPEG2 (Moving Picture Experts Group) and H.264, which have been established as technologies for coding video signals.

There are similarities between MPEG2 and H.264 in that each image is divided into blocks referred to as macroblocks and that temporal correlations are used and frequency transformation is performed on a macroblock-by-macroblock basis. However, there are also many differences between MPEG2 and H.264. Consequently, it is necessary to decode coded bit streams and then newly re-code them in the case where the bit streams coded in different coding methods are to be interconnected and/or to be reproduced by a reproducer which is only compatible to its corresponding coding method.

Conventionally, when coding methods are converted, a coding parameter used in the initial coding is extracted for decoding the coded bit streams. There are methods which have been devised for use in re-coding the extracted coding parameters (see, for example, Japanese Unexamined Patent Application Publication 2003-9158, hereinafter referred to as Patent Reference 1).

FIG. 1 is a diagram illustrating a structure of a conventional apparatus. A decoding unit 60 decodes MPEG2 coded streams. A coding parameter extracting unit 61 extracts coding parameters, such as motion vector information. A coding unit 62 re-codes, into the MPEG2 streams, image data decoded by the decoding unit 60, using a coding parameter extracted by the coding parameter extracting unit 61. According to such a conventional apparatus, it is possible to determine a motion vector to perform re-coding using the motion vector information extracted when the coded streams are decoded. Therefore, compared to the case of detecting motion vectors of all macroblocks, it is possible to achieve efficient re-coding since processing computation amounts are significantly reduced, coding amounts generated at the time of re-coding can be prevented from an increase, and image quality at the time of re-coding can be prevented from deterioration.

### SUMMARY OF THE INVENTION

According to the moving picture coding apparatus described in Patent Reference 1, a coding parameter of MPEG2 (motion vector information, for example) extracted from the initial bit stream can be used as a coding parameter (motion vector, for example) of H.264 in the same sense. However, a new technique (plural reference pictures can be used, for example) and a coding parameter which are not included in MPEG2 have been introduced to H.264. As a result, conventionally there has been a problem that the coding parameters of MPEG2 cannot be used when determining the newly introduced coding parameters of H.264.

The present invention has been conceived in view of solving the above described problem, and an object thereof is to provide a moving picture coding apparatus capable of using coding parameters of a first coding method when determining a newly introduced coding parameter of a second coding method.

In order to achieve the above mentioned object, the moving picture coding apparatus according to the present invention is an apparatus which codes image data and includes: a decoding unit which decodes image data coded in a first coding method; an extracting unit which extracts, from the image data coded in the first coding method, a first coding parameter which is a coding parameter of the first coding method; a judging unit which judges, based on the first coding parameter extracted by the extracting unit, a degree of correlation between the image data coded in the first coding method and a reference picture of the image data; a determining unit which determines, based on a result of the judgment by the judging unit, a second coding parameter which is a coding parameter of a second coding method; and a coding unit which codes, in the second coding method, the image data decoded by the decoding unit, using the second coding parameter determined by the determining unit. With this, the degree of correlation between the image data coded in the first coding method and its reference picture is judged based on the first coding parameter, and the second coding parameter is determined based on the result of the judgment. In other words, it is possible to use the coding parameter of the first coding method when determining the newly introduced coding parameter of the second coding method.

Here, the judging unit may judge, for each reference picture, the number of times that the reference picture is referred to, as an indicator which indicates the degree of correlation between the image data and the reference picture of the image data, and the determining unit may preferentially determine the reference picture which is referred to a greater number of times, as a reference picture used in coding in the second coding method. With this, it is possible to reduce processing amounts generated at the time of coding in the second coding method, since only the reference picture with a great degree of correlation is selected.

Also, the judging unit may judge, for each reference picture, the number of times that the reference picture is referred to, as an indicator which indicates the degree of correlation between the image data and the reference picture of the image data, and the determining unit may assign, to the reference picture which is referred to a greater number of times, an index having a smaller coding amount as an index of a reference picture used in the second coding method. With this, it is possible to improve compression efficiency of the second coding method, since the index having the smaller coding amount is assigned to the reference picture with a greater degree of correlation.

Further, the decoding unit the decoding unit may decode the image data coded in MPEG2, and the coding unit may code, in H.264, the image data decoded by the decoding unit. With this, it is possible to use the coding parameters of MPEG2 when determining the newly introduced coding parameter of H.264.

Note that the present invention can be embodied not only as a moving picture coding apparatus as described above, but also as: an integrated circuit having the characteristic units included in the moving picture coding apparatus; a moving picture coding method having, as steps, the characteristic units included in the moving picture coding apparatus; and a program which causes a computer to execute such steps. Furthermore, it is needless to say that such a program can be distributed via a recoding medium such as CD-ROMs, and via a transmitting medium such as the Internet.

As apparent from the above description, according to the moving picture coding apparatus of the present invention, the degree of correlation between image data coded in a first coding method and its reference picture is judged based on a first coding parameter, and a second coding parameter is determined based on the result of the judgment. In other words, it is possible to use the coding parameter of the first coding method when determining a newly introduced coding parameter of the second coding method.

### FURTHER INFORMATION ABOUT TECHNICAL BACKGROUND TO THIS APPLICATION

The disclosure of Japanese Patent Application No. 2006-346015 filed on Dec. 22, 2006 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram illustrating a structure of a conventional apparatus;

FIG. 2 is a block diagram illustrating a structure of a moving picture coding apparatus according to a first embodiment of the present invention;

FIG. 3 is a diagram for describing a frame structure and a field structure;

FIG. 4 is a table for describing types of prediction in MPEG2;

FIG. 5A is a diagram for describing frame prediction of a frame-structured picture of MPEG2;

FIG. 5B is a diagram for describing field prediction of a frame-structured picture of MPEG2;

FIG. 6A is a diagram for describing field prediction of a field-structured picture of MPEG2;

FIG. 6B is a diagram for describing 16×8 prediction of a field-structured picture of MPEG2;

FIG. 7A is a diagram illustrating that there is one reference picture (frame picture);

FIG. 7B is a diagram for describing frame prediction of a frame-structured picture of MPEG2;

FIG. 7C is a diagram for describing field prediction of a frame-structured picture of MPEG2;

FIG. 8A is a diagram illustrating that there is one reference picture (frame picture);

FIG. 8B is a diagram for describing field prediction of a field-structured picture of MPEG2;

FIG. 8C is a diagram for describing 16×8 prediction of a field-structured picture of MPEG2;

FIG. 9 is a flowchart illustrating operations of a re-coding parameter determining unit 12; and

FIG. 10 is a flowchart illustrating operations of the re-coding parameter determining unit 12.

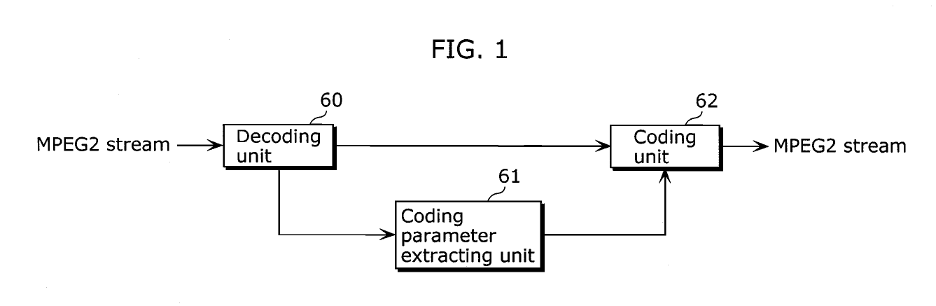

### DESCRIPTION OF THE PREFERRED EMBODIMENTS

With reference to the drawings, an embodiment of the present invention shall be described in detail below.

### First Embodiment

First, a description shall be provided on a structure of a moving picture coding apparatus according to a first embodiment of the present invention.

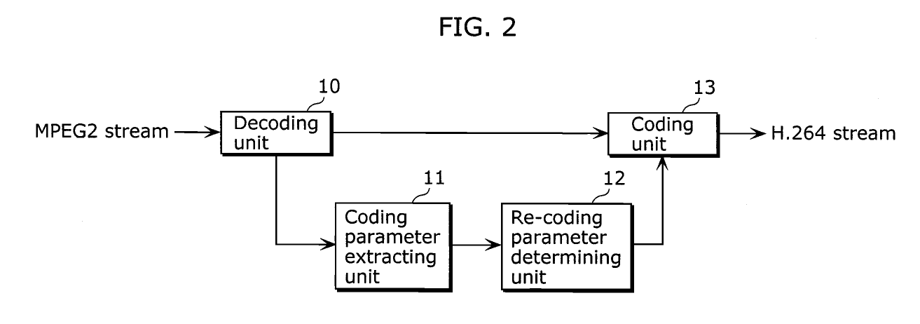

FIG. 2 is a block diagram illustrating a structure of a moving picture coding apparatus according to the first embodiment of the present invention. As illustrated in the figure, the moving picture coding apparatus receives coded MPEG2 bit streams (MPEG2 streams) as inputs, outputs re-coded H.264 bit streams (H.264 streams), and includes a decoding unit 10, a coding parameter extracting unit 11, a re-coding parameter determining unit 12, and a coding unit 13. Before describing the function of each unit, a summary of the present invention shall be provided.

First of all, MPEG2 is an example of the first coding method of the present invention, and H.264 is an example of the second coding method of the present invention. A new coding parameter named RefIdx has been introduced to H.264 as an index indicating a reference picture. In the present embodiment, a coding parameter (motion information) of MPEG2 is used in determining the RefIdx. To be more specific, the degree of correlation between image data coded in MPEG2 and its reference picture is judged, and the coding parameter of H.264 (RefIdx) is determined based on the result of the judgment. Here, it is assumed that frame-structured MPEG2 streams or field-structured MPEG2 streams are converted into field-structured H.264 streams.

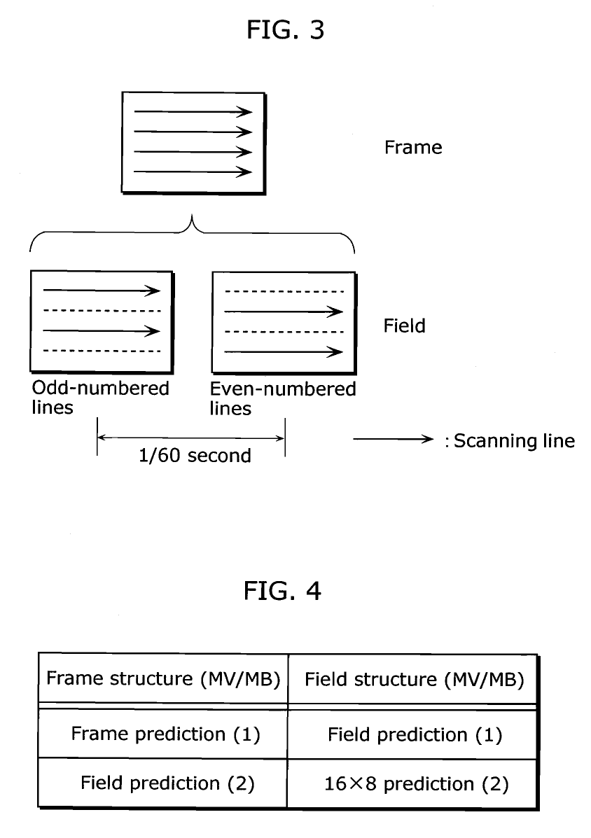

FIG. 3 is a diagram for describing a frame structure and a field structure. For a TV image, a sheet of an image (frame) is made up of two sheets of an image (field) having a line on every other row. Such an image is referred to as an interlaced picture. There is a temporal difference of 1/60 second between one field and another field. With MPEG2, a field or a frame can be selected as a unit of coding. When there is a little movement in the image, the degree of correlation between the two fields is great, and thus it is more advantageous to use the frame structure in which the entire frame is used for processing. On the other hand, when there is a large movement in the image, the degree of correlation between the two fields is less, and thus it is more advantageous to use the field structure for separate processing.

FIG. 4 is a table for describing types of prediction in MPEG2. As illustrated in the figure, in the case of the frame structure, prediction methods called frame prediction and field prediction are used, and in the case of the field structure, prediction methods called field prediction and 16×8 prediction are used. The (MV/MB) in the figure indicates the number of motion vectors per macroblock in the case of forward prediction.

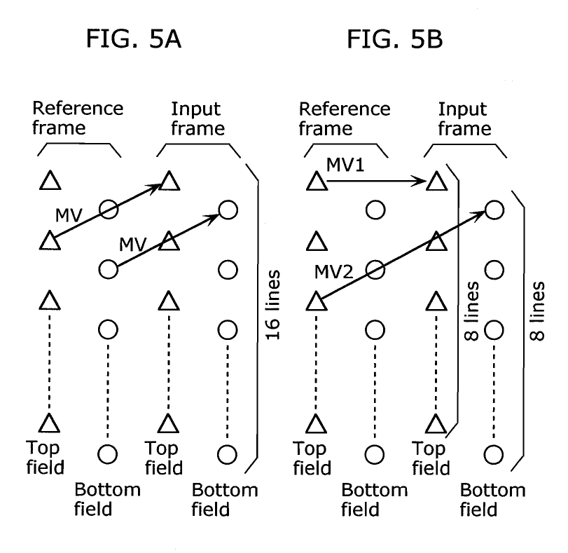

FIGS. 5A and 5B are diagrams for describing frame prediction and field prediction of a frame-structured picture of MPEG2. With frame prediction, prediction is performed on every frame in which two interlaced fields are synthesized. FIG. 5A illustrates a case example where forward prediction is performed with reference to a reference frame which is one frame away. On the other hand, with field prediction, prediction is performed on every field. In FIG. 5B, prediction is performed using MV1 in the top field and MV2 in the bottom field. A reference field may be either the top field or the bottom field, and is set by a motion_vertical_field_select flag which is in macroblock data. In FIG. 5B, the top field is used as a reference field for both the top field and the bottom field.

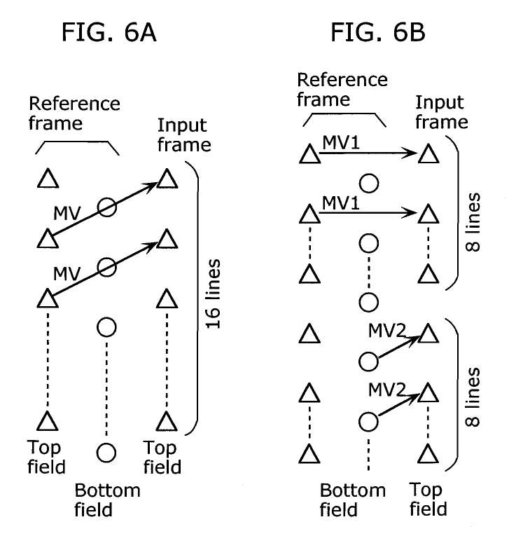

FIGS. 6A and 6B are diagrams for describing field prediction and 16×8 prediction of a field-structured picture of MPEG2. With field prediction, as illustrated in FIG. 6A, prediction is performed on every 16 pixels×16 lines (hereinafter simply referred to as 16×16). On the other hand, with 16×8 prediction, as illustrated in FIG. 6B, prediction is performed on every divided unit which is obtained by dividing each macroblock of 16 pixels×16 lines into two 16×8 blocks, one 16×8 block having the top 8 lines, and the other 16×8 block having the bottom 8 lines. As illustrated in FIG. 6B, the reference field referred to by the top block may be different from the reference field referred to by the bottom block. As a result, efficiency on predicting fine movements can be enhanced.

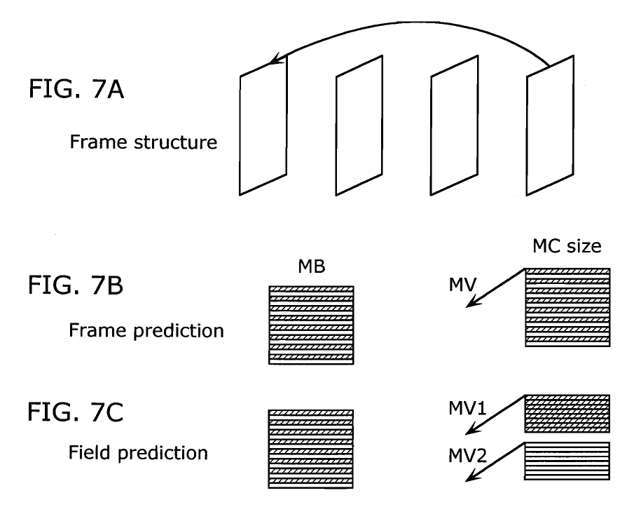

A further detailed description on frame prediction and field prediction of a frame-structured picture of MPEG2 shall be provided below. Here, as illustrated in FIG. 7A, the description is provided on an assumption that there is one reference picture (frame picture). In this case, with frame prediction, as illustrated in FIG. 7B, every 16×16 macroblock has one motion vector. On the other hand, with field prediction, as illustrated in FIG. 7C, every 16×8 block having odd-numbered lines or even-numbered lines of a macroblock has one motion vector, and every 16×16 macroblock as a whole has two motion vectors.

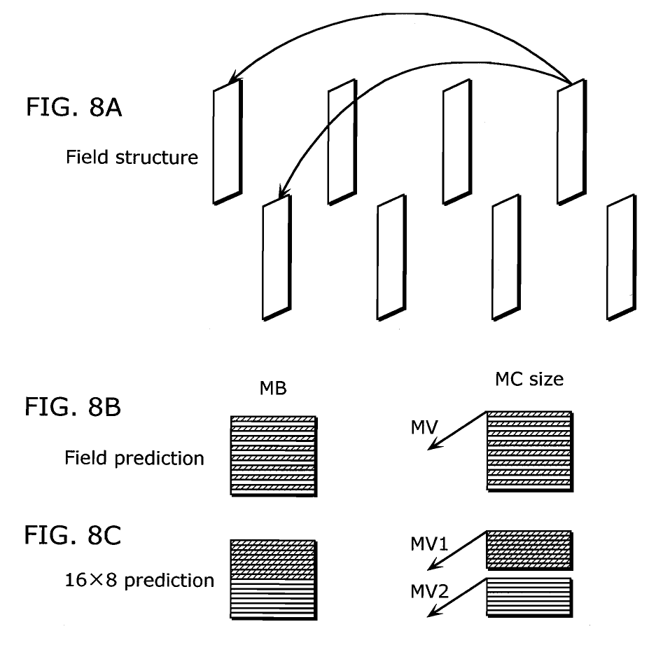

Next, a further detailed description on field prediction and 16×8 prediction of a field-structured picture of MPEG2 shall be provided. Here, as illustrated in FIG. 8A, the description is provided on the assumption that there is one reference picture (frame picture). In this case, with field prediction, as illustrated in FIG. 8B, every 16×16 macroblock has one motion vector. On the other hand, with 16×8 prediction, as illustrated in FIG. 8C, every 16×8 block having odd-numbered lines or even-numbered lines of a macroblock has one motion vector, and every 16×16 macroblock as a whole has two motion vectors.

With MPEG2, two frame pictures can be referred to. In such a case, each macroblock can have twice as many motion vectors as each macroblock has when there is one reference picture. The motion_vertical_field_select flag indicates which one of the top field and the bottom field of the reference picture is used. When a value of the flag is “0”, it indicates that the top field of the reference picture is used. On the other hand, when the value of the flag is “1”, it indicates that the bottom field of the reference picture is used.

Next, the function of each unit of the moving picture coding apparatus according to the embodiment of the present invention shall be described. As illustrated in FIG. 2, the moving picture coding apparatus includes a decoding unit 10, a coding parameter extracting unit 11, a re-coding parameter determining unit 12, and a coding unit 13.

The decoding unit 10 is an example of the decoding unit of the present invention, and decodes image data coded in a first coding method. To be more specific, the decoding unit 10 decodes an MPEG2 stream and outputs decoded image data.

The coding parameter extracting unit 11 is an example of the extracting unit of the present invention, and extracts, from the image data coded in the first coding method, a first coding parameter which is a coding parameter of the first coding method. To be more specific, the coding parameter extracting unit 11 extracts a coding parameter from the MPEG2 stream when the decoding unit 10 performs decoding. The coding parameter is information including motion vector information used at the time of coding, and indicating, with respect to every field of the MPEG2 stream, which reference picture is referred to by how many macroblocks. With frame-structured pictures, the coding parameter extracting unit 11 extracts the motion_vertical_field_select flag in the case of macroblocks of field prediction, and extracts vertical components of motion vectors in the case of macroblocks of frame prediction. On the other hand, with field-structured pictures, the coding parameter extracting unit 11 extracts the motion_vertical_field_select flag in the case of macroblocks of field prediction and of 16×8 field prediction.

The re-coding parameter determining unit 12 is an example of the judging unit and the determining unit of the present invention, and judges the degree of correlation between image data coded in the first coding method and its reference picture based on the first coding parameter extracted by the extracting unit, and determines a second coding parameter which is a coding parameter of a second coding method based on the result of the judgment. In other words, the re-coding parameter determining unit 12 determines a re-coding parameter used in field-structured H.264 coding, using a coding parameter extracted by the coding parameter extracting unit 11. The re-coding parameter here refers to List and RefIdx, for example. List 0 indicates that the main direction of prediction is forward, and List 1 indicates that the main direction of prediction is backward. RefIdx is a reference picture number indicating a reference picture which is information necessary for motion compensation, and it is assumed that “0” is a default value.

The coding unit 13 is an example of the coding unit of the present invention, and codes, in the second coding method, image data decoded by the decoding unit, using the second coding parameter determined by the determining unit. More specifically, the coding unit 13 re-codes, into an H.264 stream, image data decoded by the decoding unit 10, using a re-coding parameter determined by the re-coding parameter determining unit 12.

Now, operations of the re-coding parameter determining unit 12 shall be described in further detail.

In the present embodiment, it is assumed that re-coding is performed into field-structured H.264 streams. Therefore, the re-coding parameter determining unit 12 counts, on a field-by-field basis, how many macroblocks refer to each field picture. Taking a B-picture as an example, the re-coding parameter determining unit 12 counts, for every field to be coded, the number of macroblocks that refer to the preceding top field picture, the number of macroblocks that refer to the preceding bottom field picture, the number of macroblocks that refer to the subsequent top field picture, and the number of macroblocks that refer to the subsequent bottom field picture.

The field picture referred to by the greatest number of macroblocks has the greatest degree of correlation with the current field among the fields that are referred to by the original bit stream. Thus, selecting such a field picture as a reference picture used in re-coding produces the maximum coding efficiency. To put it the other way around, the field picture referred to by the least number of macroblocks has the least degree of correlation with the current field among the fields that are referred to by the original bit stream. Thus, even when such a field picture is removed from the reference pictures used in re-coding, the impact on the image is the least.

In the present embodiment, using the counted values described above, the reference picture with a greater degree of correlation (influential reference picture on the image) is preferentially determined as a reference picture used in coding in H.264. For example, the reference picture having the least degree of correlation is selected and removed from the reference pictures. By doing so, it is possible to reduce processing amounts generated at the time of coding in H.264, since only the reference pictures with a great degree of correlation are selected. Compared to MPEG2, motion vectors of H.264 are high in precision, and H.264 offers a variety of sizes of motion compensation, meaning that the processing amounts for vector search are great. For this reason, it is very effective to employ a technique of reducing reference pictures as a technique of reducing processing amounts generated at the time of re-coding.

Furthermore, in the present embodiment, an index having a smaller coding amount is assigned to the reference picture with a greater degree of correlation, as an index of a reference picture of H.264. For example, RefIdx “0” is assigned as an index of a reference picture with the greatest degree of correlation. Assigning, as described above, RefIdx “0” as the index of the reference picture referred to the greatest number of times enables improvement in the compression efficiency, since the coding amount of RefIdx “0” is zero.

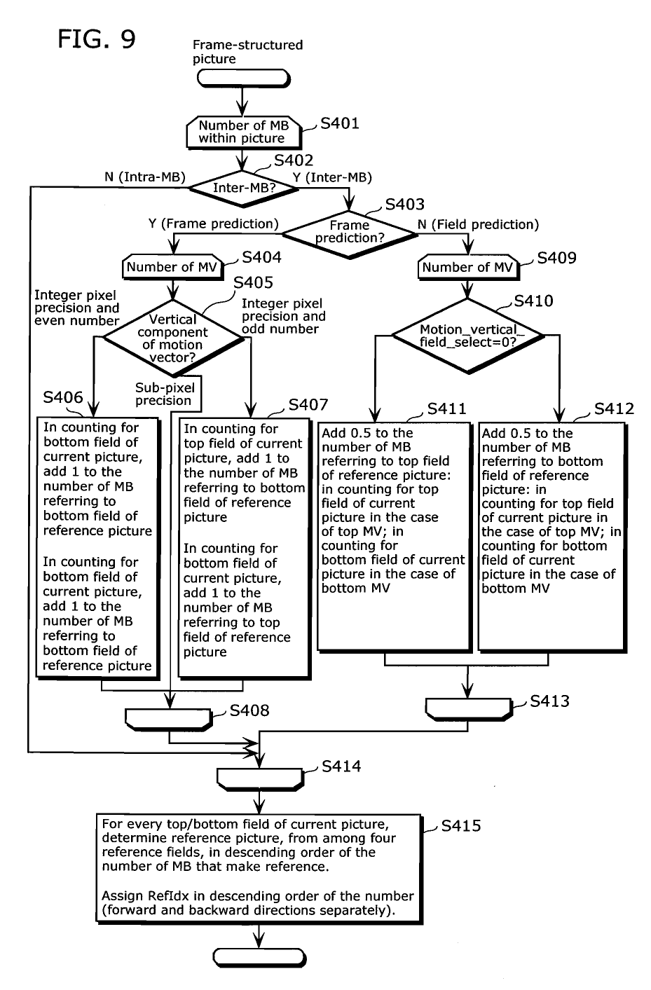

FIG. 9 is a flowchart illustrating operations of the re-coding parameter determining unit 12. Here, it is assumed that frame-structured MPEG2 streams are converted into field-structured H.264 streams. The following description is based on an assumption that the current picture is a B-picture.

First, a judgment is made on whether a macroblock (MB) in the current picture is an intra-MB or an inter-MB (S402). In the case of an intra-MB, it is not counted since there is no reference picture. In the case of an inter-MB, a judgment is made on whether prediction is frame prediction or field prediction (S403).

In the case of an inter-MB and frame prediction, a reference field is judged based on a vertical component of a motion vector. To be more specific, a judgment is made on whether the vertical component of the motion vector included in the MB is at an integer pixel precision location or a sub-pixel precision location, and in the case of the integer pixel precision location, a further judgment is made on whether the value of the vertical component is an even number or an odd number (S405).

When the vertical component of the motion vector is at the sub-pixel precision location, it is not counted.

When the vertical component of the motion vector is at the integer pixel precision location and its value is an even number, coding for the top field portion included in the macroblock is performed on the difference between the top field portion and the top field of the reference picture, and coding for the bottom field portion included in the macroblock is performed on the difference between the bottom field portion and the bottom field of the reference picture. Therefore, when counting for the top field of the current picture, 1 is added to the number of macroblocks that refer to the preceding top field picture or the number of macroblocks that refer to the subsequent top field picture, depending on the prediction direction (S406). Also, when counting for the bottom field of the current picture, 1 is added to the number of macroblocks that refer to the preceding bottom field picture or the number of macroblocks that refer to the subsequent bottom field picture, depending on the prediction direction (S406).

When the vertical component of the motion vector is at the integer pixel precision location and its value is an odd number, coding for the top field portion included in the macroblock is performed on the difference between the top field portion and the bottom field of the reference picture, and coding for the bottom field portion included in the macroblock is performed on the difference between the bottom field portion and the top field of the reference picture. Therefore, when counting for the top field of the current picture, 1 is added to the number of macroblocks that refer to the preceding bottom field picture or the number of macroblocks that refer to the subsequent bottom field picture, depending on the prediction direction (S407). Also, when counting for the bottom field of the current picture, 1 is added to the number of macroblocks that refer to the preceding top field picture or the number of macroblocks that refer to the subsequent top field picture, depending on the prediction direction (S407).

These judgments are repeatedly made on all motion vectors included in the macroblock.

In the case of an inter-MB and field prediction, a judgment is made on whether the motion_vertical_field_select flag related to the motion vector indicates 0 or 1 (S410). When the motion_vertical_field_select flag indicates 0, 0.5 is added to the number of macroblocks that refer to the top field picture in counting for the top or bottom field of the current picture, depending on whether the motion vector belongs to the top or bottom field of the current picture. When the prediction direction is also taken into account, 0.5 is added to the number of macroblocks that refer to the preceding top field picture or the number of macroblocks that refer to the subsequent top field picture (S411). Further, when the motion_vertical_field_select flag indicates 1, 0.5 is added to the number of macroblocks that refer to the bottom field picture in counting for the top or bottom field of the current picture, depending on whether the motion vector belongs to the top or bottom field of the current picture. When the prediction direction is also taken into account, 0.5 is added to the number of macroblocks that refer to the preceding bottom field picture or the number of macroblocks that refer to the subsequent bottom field picture (S412).

These judgments are repeatedly made on all motion vectors included in the macroblock.

These above described judgments are made on all macroblocks included in the current picture so as to count how many MBs included in the top and bottom fields of the current picture refer to each reference field. Then, for every top and bottom field of the current picture, the reference fields are determined as reference pictures, in order starting from the reference field to which the greatest number of macroblocks refer. In the case of an MPEG2 B-picture, two frame pictures (four field pictures) can be used at maximum as reference pictures. Here, in the case where three field pictures are to be used as reference pictures for re-coding into H.264 streams, the top three field pictures in the descending order of the number of macroblocks that refer to the field pictures are determined as reference pictures.

Further, with H.264, the index (RefIdx) of a reference picture specifies the reference picture. A smaller value of an index of a reference picture means a shorter length of coding bits. Therefore, by making the value of the index of the reference picture referred to by many macroblocks a small value, improvement in the compression efficiency can be achieved. Also in determining the index of a reference picture, an index having a smaller value is assigned to a reference picture which is referred to by a greater number of macroblocks, that is, the index is determined in accordance with the descending order of the number of macroblocks that refer to the reference pictures (S415).

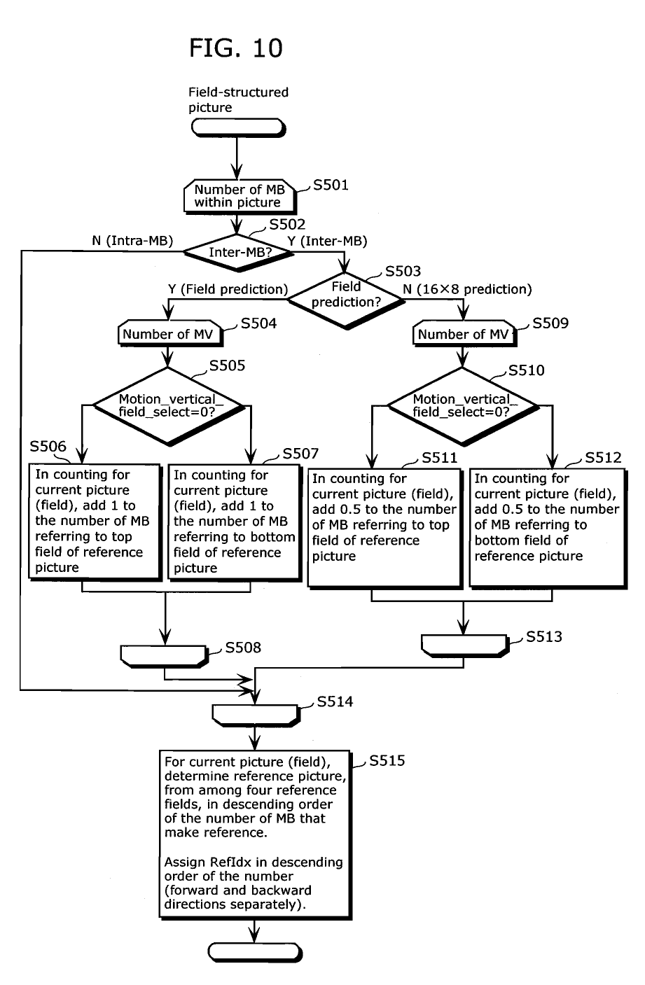

FIG. 10 is a flowchart illustrating operations of the re-coding parameter determining unit 12. Here, it is assumed that field-structured MPEG2 streams are converted into field-structured H.264 streams. The following description is based on an assumption that the current picture is a B-picture.

First, a judgment is made on whether a macroblock (MB) in the current picture is an intra-MB or an inter-MB (S502). In the case of an intra-MB, it is not counted since there is no reference picture. In the case of an inter-MB, a judgment is made on whether prediction is field prediction or 16×8 prediction (S503).

In the case of an inter-MB and field prediction, a judgment is made on whether the motion_vertical_field_select flag related to a motion vector indicates 0 or 1 (S505). When the motion_vertical_field_select flag indicates 0, 1 is added to the number of macroblocks that refer to the top field in counting for the current picture (field). When the prediction direction is also taken into account, 1 is added to the number of macroblocks that refer to the preceding top field picture or the number of macroblocks that refer to the subsequent top field picture (S506). Also, when the motion_vertical_field_select flag indicates 1, 1 is added to the number of macroblocks that refer to the bottom field in counting for the current picture (field). When the prediction direction is also taken into account, 1 is added to the number of macroblocks that refer to the preceding bottom field picture or the number of macroblocks that refer to the subsequent bottom field picture (S507). These judgments are repeatedly made on all motion vectors included in the macroblock.

In the case of an inter-MB and 16×8 prediction, a judgment is made on whether the motion_vertical_field_select flag related to a motion vector indicates 0 or 1 (S510). When the motion_vertical_field_select flag indicates 0, 0.5 is added to the number of macroblocks that refer to the top field in counting for the current picture (field). When the prediction direction is also taken into account, 0.5 is added to the number of macroblocks that refer to the preceding top field picture or the number of macroblocks that refer to the subsequent top field picture (S511). Also, when the motion_vertical_field_select flag indicates 1, 0.5 is added to the number of macroblocks that refer to the bottom field in counting for the current picture (field). When the prediction direction is also taken into account, 0.5 is added to the number of macroblocks that refer to the preceding bottom field picture or the number of macroblocks that refer to the subsequent bottom field picture (S512). These judgments are repeatedly made on all motion vectors included in the macroblock.

These above described judgments are made on all macroblocks included in the current picture so as to count how many MBs included in the current picture (field) refer to each reference field. Then, for the current picture (field), the reference fields are determined as reference pictures in order starting from the reference field to which the greatest number of macroblocks refer. In the case of an MPEG2 B-picture, two frame pictures (four field pictures) can be used at maximum as reference pictures. Here, in the case where three field pictures are to be used as reference pictures for re-coding into H.264 streams, the top three field pictures in the descending order of the number of macroblocks that refer to the field pictures are determined as reference pictures.

Further, with H.264, the index (RefIdx) of a reference picture specifies the reference picture. A smaller value of an index of a reference picture means a shorter length of coding bits. Therefore, by making the value of the index of the reference picture referred to by many macroblocks a small value, improvement in the compression efficiency can be achieved. Also in determining the index of a reference picture, an index having a smaller value is assigned to a reference picture which is referred to by a greater number of macroblocks, that is, the index is determined in accordance with the descending order of the number of macroblocks that refer to the reference pictures (S515).

As apparent from the above description, according to the moving picture coding apparatus of the present invention, the degree of correlation between the image data coded in MPEG2 and its reference picture is judged based on the coding parameter of MPEG2, and a coding parameter of H.264 is determined based on the result of the judgment. In other words, it is possible to use coding parameters of MPEG2 when determining newly introduced coding parameters of H.264. As a result, significant reduction of processing amounts can be achieved as compared to the case of determining newly introduced coding parameter of H.264 without using the coding parameters of MPEG2.

To be more specific, a reference picture with a greater degree of correlation is preferentially determined as a reference picture used in coding in H.264. For example, the reference picture with the least degree of correlation is selected and removed from the reference pictures. By doing so, it is possible to reduce processing amounts generated at the time of coding in H.264, since only the reference pictures with a great degree of correlation are selected. Compared to MPEG2, motion vectors of H.264 are high in precision, and H.264 offers a variety of sizes of motion compensation, meaning that the processing amounts for vector search are great. For this reason, it is very effective to employ a technique of reducing reference pictures as a technique of reducing processing amounts generated at the time of re-coding.

Furthermore, an index having a smaller coding amount is assigned to a reference picture with a greater degree of correlation, as an index of a reference picture used in H.264. For example, RefIdx “0” is assigned as an index of a reference picture with the greatest degree of correlation. Assigning, as described above, RefIdx “0” as the index of the reference picture referred to by the greatest number of macroblocks enables improvement in the compression efficiency, since the coding amount of RefIdx “0” is zero.

The above description has illustrated a case example where a newly introduced coding parameter of H.264 (RefIdx, for example) is determined based on a coding parameter of MPEG2 (motion information). Note, however, that the coding parameter of the first coding method and the coding parameter of the second coding method are not particularly limited to these. In other words, in the embodiment, the number of times that reference is made is counted using a coding parameter of the first coding method, however, this is equivalent to examining the characteristic of a group of coding parameters (a parameter set) of the first coding method. Therefore, a similar advantage can be obtained, as long as the following technique is employed: the technique of judging the characteristic of the coding parameter set of the first coding method and determining a coding parameter of the second coding method based on the result of the judgment.

Further, although the flowcharts of FIGS. 9 and 10 have been described with the assumption of B-pictures, the present invention can also be applied to P-pictures. However, with P-pictures, reference can be made only in one direction, consequently, instead of counting the number of times that four field pictures are referred to, the number of times that two field pictures are referred to is counted. With respect to other aspects, it is fundamentally the same as the case of B-pictures, thus detailed description thereof is omitted here.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

The present invention can be applied to moving picture coding apparatuses and moving picture coding methods, and can particularly be applied to personal computers, Personal Digital Assistants (PDAs), cellular phones, and digital broadcasting stations equipped with a communication function.

What is claimed is:

1. A moving picture coding apparatus which codes a moving picture, comprising:
a decoding unit operable to decode image data coded in a first coding method;
an extracting unit operable to extract, from the image data coded in the first coding method, a first coding parameter which is a coding parameter of the first coding method;
a judging unit operable to judge, based on the first coding parameter extracted by said extracting unit, a degree of correlation between the image data coded in the first coding method and a reference picture of the image data;
a determining unit operable to determine, based on a result of the judgment by said judging unit, a second coding parameter which is a coding parameter of a second coding method; and
a coding unit operable to code, in the second coding method, the image data decoded by said decoding unit, using the second coding parameter determined by said determining unit.

2. The moving picture coding apparatus according to claim 1,
wherein said judging unit is operable to judge, for each reference picture, the number of times that the reference picture is referred to, as an indicator which indicates the degree of correlation between the image data and the reference picture of the image data, and
said determining unit is operable to preferentially determine the reference picture which is referred to a greater number of times, as a reference picture used in coding in the second coding method.

3. The moving picture coding apparatus according to claim 1,
wherein said judging unit is operable to judge, for each reference picture, the number of times that the reference picture is referred to, as an indicator which indicates the degree of correlation between the image data and the reference picture of the image data, and
said determining unit is operable to assign, to the reference picture which is referred to a greater number of times, an index having a smaller coding amount as an index of a reference picture used in the second coding method.

4. The moving picture coding apparatus according to claim 1,
wherein said decoding unit is operable to decode the image data coded in MPEG2, and
said coding unit is operable to code, in H.264, the image data decoded by said decoding unit.

5. A moving picture coding method for coding a moving picture, comprising:
decoding image data coded in a first coding method;
extracting, from the image data coded in the first coding method, a first coding parameter which is a coding parameter of the first coding method;
judging, based on the first coding parameter extracted in said extracting, a degree of correlation between the image data coded in the first coding method and a reference picture of the image data;
determining, based on a result of the judgment in said judging, a second coding parameter which is a coding parameter of a second coding method; and
coding, in the second coding method, the image data decoded in said decoding, using the second coding parameter determined in said determining.

6. A computer program product for coding a moving picture, said computer program product, when loaded into a computer, allowing the computer to execute:
decoding image data coded in a first coding method;
extracting, from the image data coded in the first coding method, a first coding parameter which is a coding parameter of the first coding method;
judging, based on the first coding parameter extracted in the extracting, a degree of correlation between the image data coded in the first coding method and a reference picture of the image data;
determining, based on a result of the judgment in the judging, a second coding parameter which is a coding parameter of a second coding method; and
coding, in the second coding method, the image data decoded in the decoding, using the second coding parameter determined in the determining.

7. An integrated circuit for coding a moving picture, comprising:
a decoding unit operable to decode image data coded in a first coding method;
an extracting unit operable to extract, from the image data coded in the first coding method, a first coding parameter which is a coding parameter of the first coding method;
a judging unit operable to judge, based on the first coding parameter extracted by said extracting unit, a degree of correlation between the image data coded in the first coding method and a reference picture of the image data;
a determining unit operable to determine, based on a result of the judgment by said judging unit, a second coding parameter which is a coding parameter of a second coding method; and
a coding unit operable to code, in the second coding method, the image data decoded by said decoding unit, using the second coding parameter determined by said determining unit.
